(19) United States
(12) Patent Application Publication
(10) Pub. No.: US 2018/0047085 A1
(43) Pub. Date: Feb. 15, 2018

(54) TICKET IDENTIFICATION IN AN ONLINE MARKETPLACE

(71) Applicant: eBay Inc., San Jose, CA (US)

(72) Inventors: Gaurav Lokesh, Dublin, CA (US); Girish Vasvani, Fremont, CA (US)

(21) Appl. No.: 15/237,601

(22) Filed: Aug. 15, 2016

(51) Int. Cl. G06Q 30/06

(52) U.S. Cl. CPC G06Q 30/0633

(57) ABSTRACT

Embodiments of the present disclosure are related to electronic commerce. A method may include identifying at least one user-defined ticket of interest including at least one attribute. The method may further include identifying at least one other ticket including at least one attribute matching the at least one attribute of the at least one user-defined ticket of interest. Further, the method may include presenting the at least one other ticket to a user upon the at least one user-defined ticket of interest becoming unavailable for purchase.

### FIELD

The present disclosure relates generally to electronic commerce. More specifically, the present disclosure includes embodiments related to ticket identification in an online marketplace.

### BACKGROUND

Some online web services enable exchange of tickets for events. The tickets may be used to reserve seats and/or admission for the events, such as sporting events, concerts, theater events, parking at such events, and other entertainment events. Using an online web service, a user may search for available tickets and decide which, if any, of available tickets are of interest based on information provided by the online web service.

The subject matter claimed herein is not limited to embodiments that solve any disadvantages or that operate only in environments such as those described above. Rather, this background is only provided to illustrate one example technology area where some embodiments described herein may be practiced.

### BRIEF DESCRIPTION OF THE DRAWINGS

Example embodiments will be described and explained with additional specificity and detail through the use of the accompanying drawings in which:

FIG. 1 illustrates an example system in which some embodiments may be implemented;

FIG. 2 is a flowchart depicting a method, in accordance with an embodiment of the present disclosure;

FIG. 3 is a flowchart depicting another method, in accordance with an embodiment of the present disclosure; and

FIG. 4 illustrates an example computing system configured for implementation of a marketplace interaction.

### DETAILED DESCRIPTION

In an online marketplace, a user may “add” an item (e.g., one or more tickets to a sporting event) to the user's electronic “shopping cart” prior to actually purchasing the item. In most cases, the user is not committed to buy the item until the user “checks out” and pays for the item. Further, until the item is paid for, the item is usually still available to other buyers. Thus, in some instances, an item, which may be in a user's electronic shopping cart, may sell to another buyer before the user purchases the item. If the item is entirely unique (e.g., a specific seat at a specific sporting event), or is available in limited quantities, the user may simply miss out on purchasing the item.

Various embodiments of the present disclosure are related to online ticket marketplaces and, more specifically to identifying one or more potential event tickets that are similar to one or more event tickets in which a user showed interest in (e.g., by adding the one or more event ticket to the user's electronic shopping cart) but was unable to purchase due to the one or more event tickets becoming unavailable (e.g., due to another user purchasing the one or more event tickets).

According to one embodiment, a system may include at least one processing element configured to identify at least one user-defined ticket of interest including at least one attribute. The at least one processing element may further be configured to identify at least one other ticket including at least one attribute matching the at least one attribute of the at least one user-defined ticket of interest. In addition, the at least one processing element may be configured to present the at least one other ticket to a user upon the at least one user-defined ticket of interest becoming unavailable for purchase.

According to other embodiments, the present disclosure includes methods for operating an online marketplace. Various embodiments of such a method may include identifying at least one user-defined ticket of interest including at least one attribute. The method may also include identifying at least one other ticket including at least one attribute matching the at least one attribute of the at least one user-defined ticket of interest. Moreover, the method may include presenting the at least one other ticket to a user upon the at least one user-defined ticket of interest becoming unavailable for purchase.

In another embodiment, a method may include identifying at least one ticket selected by a user. The method may also include identifying at least one potential ticket including at least one attribute matching at least one attribute of the at least one ticket selected by the user. In addition, the method may include recommending the at least one potential ticket to the user upon the at least one ticket selected by the user becoming unavailable for purchase.

Yet other embodiments of the present disclosure comprise computer-readable media storage storing instructions that when executed by a processor cause the processor to perform instructions in accordance with one or more embodiments described herein.

Other aspects, as well as features and advantages of various aspects, will become apparent to those of skill in the art though consideration of the ensuing description, the accompanying drawings and the appended claims.

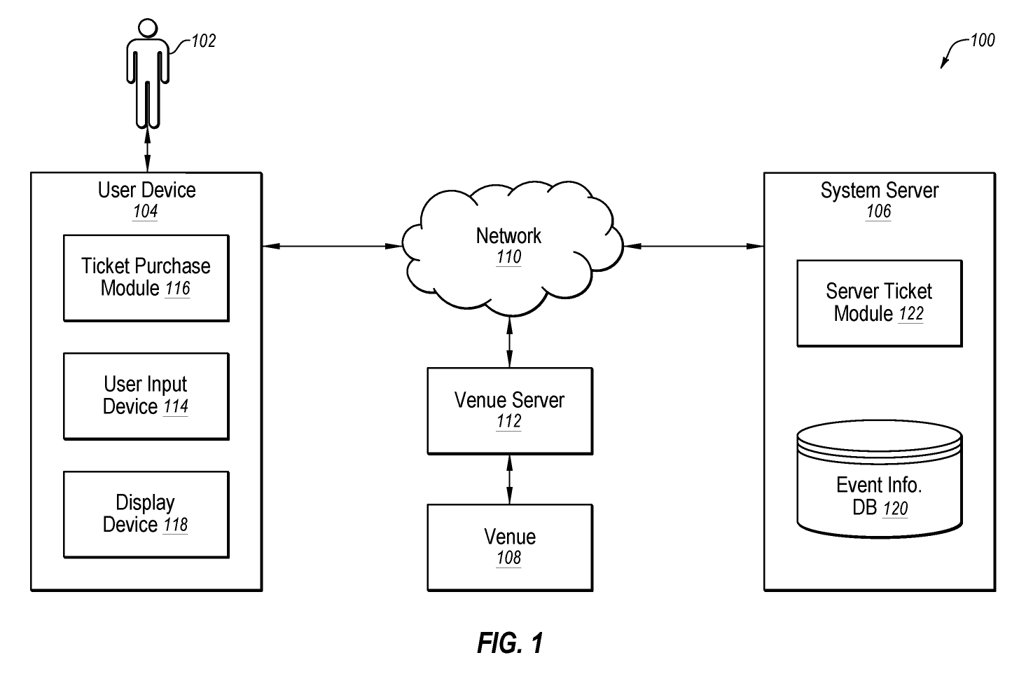

FIG. 1 illustrates an example system 100 in which an online ticket marketplace (hereinafter, “marketplace”) may be implemented. In system 100, a user 102 may interact with a user device 104 to search for and/or obtain tickets, which may be listed on a site that is hosted or controlled by a system server 106. The tickets may be for an event that occurs at a venue 108. System 100 may also include a network 110 and a venue server 112. System server 106, user device 104, and venue server 112 (collectively, environment components) may communicate data via network 110. For example, one or more of the environment components may communicate data related to ticket transactions such as user input and event information. Each of the environment components is briefly described in the following paragraphs.

Network 110 may include a wired network, a wireless network, or any combination thereof. Network 110 may include any suitable configuration or configurations including a star configuration, token ring configuration, or other configurations. Network 110 may include a local area network (LAN), a wide area network (WAN) (e.g., the Internet), and/or other interconnected data paths across which multiple devices may communicate. In some embodiments, network 110 may include a peer-to-peer network. Network 110 may also be coupled to or include portions of a telecommunications network that may enable communication of data in a variety of different communication protocols. In some embodiments, network 110 includes BLUETOOTH® communication networks and/or cellular communication networks for sending and receiving data including via short messaging service (SMS), multimedia messaging service (MMS), hypertext transfer protocol (HTTP), direct data connection, wireless application protocol (WAP), e-mail, and the like.

User 102 may include an individual or an entity that may interface with user device 104 to participate in a ticketing search or a ticketing transaction. For example, user 102 may include a person who wants to purchase a ticket for a particular event to take place at venue 108.

User device 104 may include a computing device that may include a processor, memory, and network communication capabilities. User device 104 may be configured for communication with one or more other environment components via network 110. Further, user device 104 may include a location determination device, such as a GPS device. Some examples of user device 104 include a laptop computer, a desktop computer, a tablet computer, a mobile telephone, a smartphone, a personal digital assistant (“PDA”), a mobile e-mail device, a portable game player, a portable music player, smart wearable technology, or any other applicable electronic device capable of accessing network 110.

User device 104 may include a user input device 114, a ticket purchase module 116, and a display device 118. User input device 114 may include hardware configured to notify user 102 of a communication, and/or present a communication to user 102. In some embodiments, user input device 114 may include a speaker, a microphone, a display device (e.g., display device 118), a joystick, a direction pad (D-pad), a trigger input, a motion sensor, an eye tracker, a trackpad, a thermal input capturing device, a keyboard, a touch screen, and/or other hardware devices. In these and other embodiments, user input device 114 may also be configured to receive input from user 102. The user input may include user-defined data, such as, the user's favorite sports teams, favorite performers, favorite event types (e.g., concerts, sporting events, shows, etc.), and/or preferences regarding tickets in a venue (e.g., venue 108). More specifically, for example, the user input may include user-defined ticket preferences, such as a preferred sections within a venue, preferred rows within a venue, preferred seats prices, etc. Stated another way, the user input may identify preferred ticket attributes (e.g., preferred sections, row, seats, price range, price, etc.) as defined by user 102.

Display device 118 may include a surface on which data may be displayed to user 102. In addition, in some embodiments, at least a portion of the user input may be received by display device 118. Some examples of display device 118 may include a light emitting diode (LED) display, liquid crystal displays (LCD) thin film transistor (TFT) LCD, in-place switching (IPS) LCD, resistive touchscreen LCD, capacitive touchscreen LCD, organic LED (OLED), active-matrix OLED, etc.

Ticket purchase module 116 may be configured to receive (e.g., via input device 114), and possibly process, user input. As noted above, the user input may include data related to user 102, such as, user's 102 preferences regarding tickets in a venue (e.g., venue 108) (e.g., location and/or price). In addition, ticket purchase module 116 may be configured to include, and possibly receive (e.g., from system server 106), historical data (e.g., data related to user's 102 ticket purchasing history and/or a user's ticket browsing history), location data (e.g., a location of the user), user preferences (e.g., related to tickets and/or events), and/or other data related to the user that may be used in identifying one or more potential event tickets for user 102.

Ticket purchase module 116 may be implemented using hardware including a processor, a microprocessor (e.g., to perform or control performance of one or more operations), a field-programmable gate array (FPGA), or an application-specific integrated circuit (ASIC). In some other instances, the ticket purchase module 116 may be implemented using a combination of hardware and software. As will be appreciated, implementation in software may include rapid activation and deactivation of one or more transistors or transistor elements such as may be included in hardware of a computing system (e.g., the user device 104). Additionally, software defined instructions may operate on information within transistor elements. Implementation of software instructions may at least temporarily reconfigure electronic pathways and transform computing hardware.

Venue 108 may include any forum in which an event may take place or are performed. Some examples of venue 108 may include a stadium, an arena, a theatre, a parking lot, a fairground, and the like. The event may include any type of happening in which tickets are used for entry. Some examples of the event are sporting events, concerts, plays, movies, festivals, and the like. Venue 108 may be associated with venue server 112.

Venue server 112 may include a hardware server that includes a processor, memory, and network communication capabilities. In the illustrated implementation, venue server 112 may be configured to communicate via network 110 with the other environment components. Venue server 112 may track event information that pertains to a particular event that is to occur or is occurring at venue 108. For example, the event information may include ticket prices or ticket availability.

System server 106 may include a hardware server that includes a processor, memory, and network communication capabilities. In the illustrated implementation, system server 106 is configured to communicate via network 110 with the other environment components. System server 106 may include an event information database 120 and a server ticket module 122. Event information database 120 may store event information pertaining to one or more particular events occurring at venue 108. For example, the event information may include one or more ticket prices for one or more seating sections or for one or more seats of venue 108, ticket availability for one or more seating sections or for one or more of the seats of venue 108, ticket packages for events, and the like.

The event information may originate at system server 106. For instance, the event information may be generated through sales of tickets to users. The event information may also originate at venue server 112. Venue server 112 may track ticket sales via system server 106 and/or via other systems. Venue server 112 may communicate the event information representative of the ticket sales to system server 106. Accordingly, event information database 120 may include updated event information. Although not explicitly shown in FIG. 1, the event information in event information database 120 may also originate at other sources. While event information database 120 is depicted in system server 106, in other embodiments, event information database 120 may be located remotely and accessed by system server 106.

Server ticket module 122 may be configured to identify one or more users (e.g., user 102) of system 100. Further, server ticket module 122 may be configured to track user activity, and generate and store historical data for the one or more users. Server ticket module 122 may further be configured to receive and store user-defined data and/or location data from the one or users. Server ticket module 122 may be implemented using hardware including a processor, a microprocessor (e.g., to perform or control performance of one or more operations), an FPGA, or an ASIC. In some other instances, server ticket module 122 may be implemented using a combination of hardware and software.

Server ticket module 122, ticket purchase module 116, or a combination thereof may be configured to identify one or more ticket options including one or more recommended tickets for a user based on user data and/or tickets of interest, as described herein.

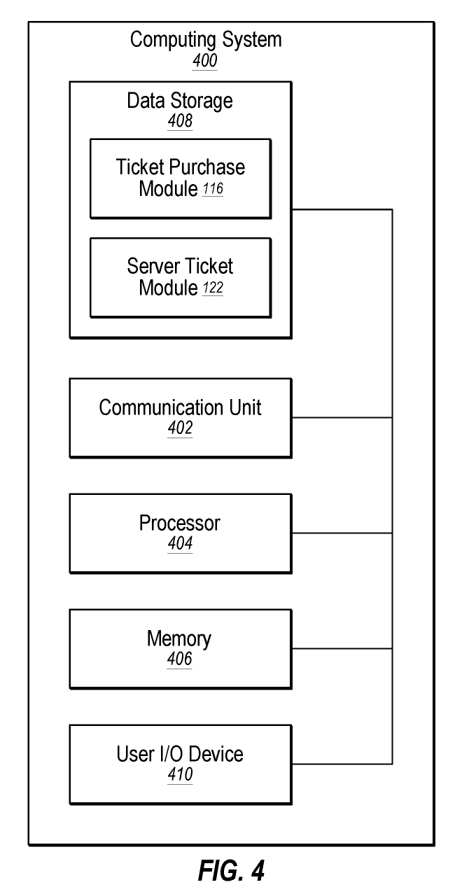

In system 100, memory in one or more of the environment components may be similar to memory 406 described with reference to FIG. 4, processors in one or more of the environment components may be similar to a processor 404 described with reference to FIG. 4, and network communication capabilities of one or more of the environment components may be provided by a communication unit 402 described with reference to FIG. 4.

Modifications, additions, or omissions may be made to system 100 without departing from the scope of the present disclosure. Specifically, embodiments depicted in FIG. 1 include one or more user devices 104, one or more users 102, one or more venue servers 112, one or more venues 108, one or more system servers 106, or any combination thereof.

Moreover, the separation of various components in the embodiments described herein is not meant to indicate that the separation occurs in all embodiments. It may be understood with the benefit of this disclosure that the described components may be integrated together in a single component or separated into multiple components. For example, in some embodiments the user input device 114 and the display device 118 may be a single device.

As noted above, various embodiments of the present disclosure relate to identifying one or more potential tickets for a user. The one or more potential tickets may be similar to one or more tickets (“tickets of interest”) in which the user showed interest in (e.g., via the user adding the one or more event ticket to the user's electronic shopping cart), but was unable to purchase due to at least one of the one or more tickets becoming unavailable (e.g., due to another user purchasing the one or more event tickets). For example, the one or more potential tickets may be the same price, or approximately the same price, as the tickets of interest, in the same section as the tickets of interest, in the same row as the tickets of interest, the same seat numbers as the tickets of interest, or any combination thereof. According to one embodiment, the one or more potential tickets may be the closest in price or closest in location to the one or more tickets of interest.

It is noted that the term “unavailable” is not limited to resulting from another user purchasing all of the tickets of interest. Rather, tickets may become “unavailable” due to a price change of at least one of the one or more of the tickets of interests and/or at least one ticket of the one or more tickets of interest being purchased by another user.

More specifically, in one example scenario, user 102 may identify one or more tickets for an event (“user-defined tickets of interests”) and “add” the one or more ticket of interest to his/her electronic shopping cart. However, in this scenario, before purchasing the one or more tickets of interest, the one or more tickets of interest become unavailable to the user due to, for example, another user purchasing the one or more tickets. In this scenario, system server 106 and/or ticket purchase module 116 may identify one or more potential tickets for the same event that are similar to the one or more tickets of interest, which are no longer available for purchase. More specifically, for example, the one or more potential tickets may include at least one attribute matching at least one attribute of the one or more user-defined tickets of interest. As example, an attribute of a ticket may include a price (e.g., a specific price or price range) of the ticket, or a location of the ticket (e.g., a seat number, a row, a section, similar view, or any combination thereof).

In another example scenario, user 102 may identify a plurality of tickets (e.g., four tickets) for an event and “add” the plurality of tickets to his/her electronic shopping cart. However, in this scenario, before purchasing the plurality of tickets, at least one ticket, but not all of the plurality of tickets, becomes unavailable to the user (e.g., due to a price change and/or another user purchasing the at least one ticket). In this scenario, user 102 may still purchase the available tickets of the identified plurality of tickets. Further, system server 106 and/or ticket purchase module 116 may identify one or more potential tickets for the same event that are similar to the at least one ticket of interest, which is no longer available for purchase. In yet another embodiment, if at least one of the identified plurality of tickets (e.g., four tickets) become unavailable, system server 106 and/or ticket purchase module 116 may identify a different plurality of tickets (e.g., four different tickets) for the same event that are similar to the plurality of tickets originally identified by user 102.

More specifically, for example, user 102 may identify four tickets (e.g., tickets for seats 1-4 in row 4, section 100) for an event and “add” the four tickets to his/her electronic shopping cart. However, in this scenario, before purchasing the four tickets, two of the four tickets (e.g., tickets for seats 3 and 4) become unavailable to the user (e.g., due to a price change and/or another user purchasing the two tickets). In this scenario, user 102 may still purchase the two available tickets (i.e., tickets for seats 1 and 2) of the identified four tickets. Further, system server 106 and/or ticket purchase module 116 may identify one or more potential tickets for the same event (e.g., tickets for seats 6 and 7 in row 3, section 100) that are similar to the two tickets, which are no longer available for purchase.

In yet another embodiment, user 102 may identify four tickets (e.g., tickets for seats 1-4 in row 4, section 100) for an event and “add” the four tickets to his/her electronic shopping cart. However, in this scenario, before purchasing the four tickets, one of the four tickets become unavailable to the user (e.g., due to a price change and/or another user purchasing the two tickets). In this scenario, system server 106 and/or ticket purchase module 116 may identify four potential tickets (e.g., tickets for seats 10-13 in row 4, section 100) for the same event that are similar the four tickets originally identified by the user.

In yet another embodiment, user 102 may identify a plurality of tickets for an event and “add” the plurality of tickets to his/her electronic shopping cart. For example, each ticket of the plurality of tickets has a price of $50.00. However, in this scenario, before purchasing the plurality of tickets, a price of at least one ticket of the plurality of ticket changes (e.g., increase to $60.00). In this scenario, system server 106 and/or ticket purchase module 116 may identify one or more potential tickets for the same event that are similar to the at least one ticket of interest and having a price of $50.00 or less.

According to one non-limiting example, user 102 may “add” a ticket of interest to an event (e.g., a football game) to his/her electronic shopping cart. In this example, the ticket is for a seat in section A, row 10, and has a price of $50.00. However, prior to purchasing the ticket of interest, the ticket of interest has become unavailable. In this scenario, system server 106, either prior to or after the ticket of interest became unavailable, may identify one or more potential tickets for the event that are similar to the ticket of interest, which is unavailable. More specifically, for example, one potential ticket identified and presented to user 102 may be for a seat in section A, row 14, and may have a price of $40.00. Another potential ticket identified and presented to user 102 may be for a seat in section B, row 10, and may have a price of $50.00.

In yet another non-limiting example, user 102 may “add” a plurality of tickets of interest to an event (e.g., a concert) to his/her electronic shopping cart. In this example, the ticket are for seats in section N, row 22, and each ticket has a price of $150.00. However, prior to to purchasing the tickets of interest, one or more of the tickets of interests are no longer available. In this scenario, system server 106, either prior to or after the one or more tickets of interest became unavailable, may identify one or more potential tickets for the event that are similar to the tickets of interest, which are unavailable. More specifically, for example, tickets for seats in section N, row 21, and having a price of $155.00 each, may be identified and presented to user 102. Other potential tickets identified and presented to user 102 may be for seats in section Y, row 22, and may have a price of $150.00 each.

Accordingly, various embodiments disclosed herein may provide a potential ticket purchaser (e.g., user 102) with one or more alternative tickets (e.g., in the event one or more other tickets that the user was considering purchasing become unavailable. The one or more alternative tickets may be quickly presented to the user, thus increasing the likelihood the potential ticket purchaser remains engaged with system server 106 and eventually purchases one or more tickets.

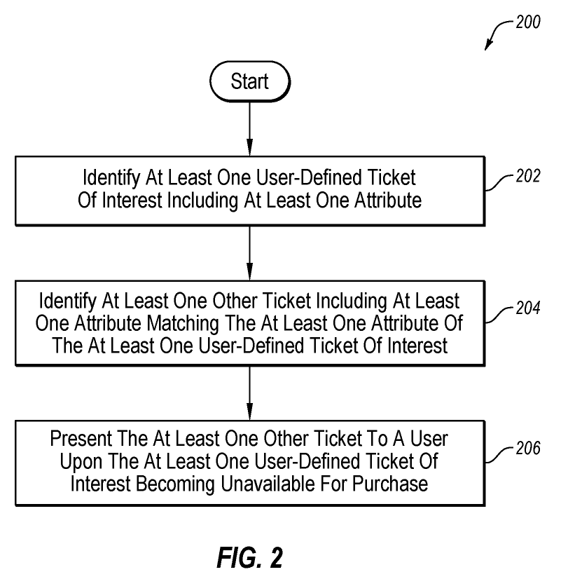

FIG. 2 is a flowchart illustrating an example method 200. Method 200 may be arranged in accordance with at least one embodiment described herein. Method 200 may be implemented, in some embodiments, by a system, such as system 100 and/or system 400 of FIGS. 1 and 4, respectively. Although illustrated as discrete blocks, various blocks of method 200 may be divided into additional blocks, combined into fewer blocks, or eliminated, depending on the desired implementation.

At block 202, at least one user-defined ticket of interest including at least one attribute (e.g., section, row, seat number, price, etc.) may be identified, and method 200 may proceed to block 204. For example, the at least one user-defined ticket of interest may be identified (e.g., via system server 106 of FIG. 1) upon user 102 (see FIG. 1) “adding” the at least one user-defined ticket of interest to the user's electronic shopping cart. In this example, the at least one user-defined ticket of interest includes tickets for seats 3 and 4 in row 4, section B. Further, each ticket may have a price of $30.00.

At block 204, at least one other ticket including at least one attribute matching the at least one attribute of the at least one user-defined ticket of interest may be identified, and method 200 may proceed to block 206. For example, system server 106 may identify two other tickets for seats 3 and 4 in row 5, section B, and having a price of $28.00 each. As another example, system server 106 may identify two other tickets for seats 9 and 10 in row 5, section B, and having a price of $30.00 each.

At block 206, the at least one other ticket may be presented to the user upon the at least one user-defined ticket of interest becoming unavailable for purchase. For example, at any time after the at least one user-defined ticket of interest becomes unavailable for purchase, system server 106 may present the at least one other ticket to the user (e.g. via display device 104).

Modifications, additions, or omissions may be made to method 200 without departing from the scope of the present disclosure. For example, the operations of method 200 may be implemented in differing order. Furthermore, the outlined operations and actions are only provided as examples, and some of the operations and actions may be optional, combined into fewer operations and actions, or expanded into additional operations and actions without detracting from the essence of the disclosed embodiments.

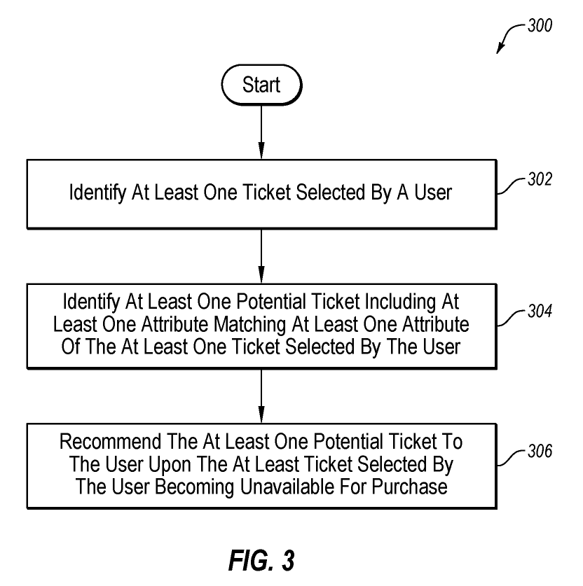

FIG. 3 is a flowchart illustrating another example method 300. Method 300 may be arranged in accordance with at least one embodiment described herein. Method 300 may be implemented, in some embodiments, by a system, such as system 100 and/or system 400 of FIGS. 1 and 4, respectively. Although illustrated as discrete blocks, various blocks of method 300 may be divided into additional blocks, combined into fewer blocks, or eliminated, depending on the desired implementation.

At block 302, at least one ticket selected by a user may be identified, and method 300 may proceed to block 304. For example, the at least one ticket selected by the user may be identified (e.g., via system server 106 of FIG. 1) upon user 102 (see FIG. 1) adding the at least one ticket to the user's electronic shopping cart.

At block 304, at least one potential ticket including at least one attribute matching at least one attribute of the at least one ticket selected by the user may be identified, and method 300 may proceed to block 306. For example, the at least one ticket selected by user 102 may include tickets for seats 12-15 in row 2, section F. Further, each ticket selected by user 102 may have a price of $200.00. Continuing with this example, system server 106 may identify potential tickets for seats 1-4 in row 6, section B, and having a price of $200.00 each. As another example, system server 106 may identify potential tickets for seats 11-14 in row 7, section F, and having a price of $190.00 each.

At block 306, the at least one potential ticket may be recommended to the user upon the at least one ticket selected by the user becoming unavailable for purchase. For example, at any time after the at least one ticket selected by the user becomes unavailable for purchase, system server 106 may recommend the at least one potential ticket to user 102 (e.g. via display device 104).

Modifications, additions, or omissions may be made to method 300 without departing from the scope of the present disclosure. For example, the operations of method 300 may be implemented in differing order. Furthermore, the outlined operations and actions are only provided as examples, and some of the operations and actions may be optional, combined into fewer operations and actions, or expanded into additional operations and actions without detracting from the essence of the disclosed embodiments.

FIG. 4 illustrates an example computing system 400. Computing system 400 may be configured for marketplace transactions, arranged in accordance with at least one embodiment described herein. Computing system 400 may include a communication unit 402, one or more processors 404, a memory 406, user input/output (I/O) device 410, and a data storage 408, which may include ticket purchase module 116 and server ticket module 122. Some examples of computing system 400 may include user device 104, system server 106, and venue server 112 discussed elsewhere in this disclosure.

Processor 404 may include any suitable special-purpose or general-purpose computer, computing entity, or processing device including various computer hardware or software modules and may be configured to execute instructions stored on any applicable computer-readable storage media. For example, processor 404 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 4, it is understood that processor 404 may include any number of processors configured to perform individually or collectively any number of operations described herein. Additionally, one or more of the processors may be present on one or more different electronic devices. In some embodiments, processor 404 may interpret and/or execute program instructions and/or process data stored in memory 406, data storage 408, or memory 406 and data storage 408. In some embodiments, processor 404 may fetch program instructions from data storage 408 and load the program instructions in memory 406. After the program instructions are loaded into memory 406, processor 404 may execute the program instructions.

Memory 406 and data storage 408 may include computer-readable storage media for carrying or having computer-executable instructions or data structures stored thereon. Such computer-readable storage media may include any available media that may be accessed by a general-purpose or special-purpose computer, such as the processor 404. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause processor 404 to perform a certain operation or group of operations.

Communication unit 402 may include hardware configured to receive and send communications. In some embodiments, communication unit 402 may include an antenna, a wired port, and/or modulation/demodulation hardware, among other communication hardware devices. In particular, communication unit 402 may be configured to receive a communication (e.g., from a remote device) and present the communication to processor 404 for classifying or to send a communication from processor 404 to another device or network.

I/O device 410 may include hardware configured to notify a user of computing system 400 of a communication, present a communication to a user, or to notify a user of a communication and present the communication to the user. In some embodiments, I/O device 410 may include a speaker, a microphone, a display, a keyboard, and/or a touch screen, among other hardware devices. In these and other embodiments, I/O device 410 may also be configured to receive input from a user of computing system 400.

In view of this disclosure, it will be appreciated that modifications, additions, or omissions may be made to system 400 without departing from the scope of the present disclosure. For example, in some embodiments, system 400 may not include I/O device 410. In these and other embodiments, system 400 may be a server or other computing device or system that monitors for occurrence of monitored events using communication unit 402. In some embodiments, the different components of system 400 may be physically separate may be communicatively coupled via any suitable mechanism. For example, data storage 408 may be part of a storage device that is separate from a server, which includes processor 404, memory 406, and the communication interface, that is communicatively coupled to the storage device.

As indicated above, the embodiments described herein may include the use of a special purpose or general purpose computer (e.g., processor 404 of FIG. 4) including various computer hardware or software modules, as discussed in greater detail below. Further, as indicated above, embodiments described herein may be implemented using computer-readable media (e.g., memory 406 of FIG. 4) for having computer-executable instructions or data structures stored thereon.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A system, comprising:
at least one processing element configured to:
identify at least one user-defined ticket of interest including at least one attribute;
identify at least one other ticket including at least one attribute matching the at least one attribute of the at least one user-defined ticket of interest; and
present the at least one other ticket to a user upon the at least one user-defined ticket of interest becoming unavailable for purchase.

2. The system of claim 1, wherein the at least one processing element is further configured to detect the at least one user-defined ticket of interest in an electronic shopping cart of the user to identify the at least one user-defined ticket of interest.

3. The system of claim 1, wherein each of the at least one attribute of the at least one user-defined ticket of interest and the at least one attribute of the at least one other ticket comprises a price range, a price, a section, a row, and a seat number.

4. The system of claim 1, wherein the at least one user-defined ticket of interest comprises at least one unique ticket.

5. The system of claim 1, wherein the at least one processing element is further configured to detect the at least one user-defined ticket of interest becoming unavailable for purchase.

6. The system of claim 1, wherein the at least one processing element is configured to identify the at least one other ticket including at least two attributes matching at least two attributes of the at least one user-defined ticket of interest.

7. The system of claim 1, wherein the at least one user-defined ticket of interest comprises at least one ticket in an electronic shopping cart of the user.

8. A method, comprising:
identifying at least one user-defined ticket of interest including at least one attribute;
identifying at least one other ticket including at least one attribute matching the at least one attribute of the at least one user-defined ticket of interest; and
presenting the at least one other ticket to a user upon the at least one user-defined ticket of interest becoming unavailable for purchase.

9. The method of claim 8, wherein identifying at least one user-defined ticket of interest comprises identifying the at least one user-defined ticket of interest in an electronic shopping cart of the user.

10. The method of claim 8, wherein identifying at least one user-defined ticket of interest comprises identifying at least one unique event ticket.

11. The method of claim 8, wherein identifying at least one other ticket including at least one attribute matching the at least one attribute of the at least one user-defined ticket of interest comprises identifying the at least one other ticket including at least one of a price range, a price, a section, and a row matching at least one of a price range, a price, a section, and a row of the at least one user-defined ticket of interest.

12. The method of claim 8, further comprising detecting the at least one user-defined ticket of interest becoming unavailable for purchase.

13. The method of claim 8, wherein identifying at least one other ticket including at least one attribute matching the at least one attribute of the at least one user-defined ticket of interest comprises identifying the at least one other ticket including at least two attributes matching at least two attributes of the at least one user-defined ticket of interest.

14. The method of claim 8, wherein identifying at least one user-defined ticket of interest comprises detecting at least one ticket being added to an electronic shopping cart of the user.

15. One or more non-transitory computer-readable media that include instructions that, when executed by one or more processors, are configured to cause the one or more processors to perform operations, the operations comprising:
identifying at least one user-defined ticket of interest including at least one attribute;
identifying at least one other ticket including at least one attribute matching the at least one attribute of the at least one user-defined ticket of interest; and
presenting the at least one other ticket to a user upon the at least one user-defined ticket of interest becoming unavailable for purchase.

16. The computer-readable media of claim 15, wherein identifying at least one user-defined ticket of interest comprises identifying the at least one user-defined ticket of interest in an electronic shopping cart of the user.

17. The computer-readable media of claim 15, wherein identifying at least one other ticket including at least one attribute matching the at least one attribute of the at least one user-defined ticket of interest comprises identifying the at least one other ticket including at least one of a price range, a price, a section, and a row matching at least one of a price range, a price a section, and a row of the at least one user-defined ticket of interest.

18. The computer-readable media of claim 15, the operations further comprising detecting the at least one user-defined ticket of interest becoming unavailable for purchase.

19. The computer-readable media of claim 15, wherein identifying at least one other ticket including at least one attribute matching the at least one attribute of the at least one user-defined ticket of interest comprises identifying the at least one other ticket including at least two attributes matching at least two attributes of the at least one user-defined ticket of interest.

20. The computer-readable media of claim 15, wherein identifying at least one user-defined ticket of interest comprises detecting at least one ticket being added to an electronic shopping cart of the user.
